(19) United States
(12) Patent Application Publication
(10) Pub. No.: US 2024/0207663 A1
(43) Pub. Date: Jun. 27, 2024

(54) HFO-1224YD FIRE EXTINGUISHING COMPOSITIONS, SYSTEMS AND METHODS

(71) Applicant: HONEYWELL INTERNATIONAL INC., Charlotte, NC (US)

(72) Inventors: ROBERT GERARD RICHARD, Charlotte, NC (US); RAJIV RATNA SINGH, Charlotte, NC (US); RYAN HULSE, Charlotte, NC (US)

(73) Assignee: HONEYWELL INTERNATIONAL INC., Charlotte, NC (US)

(21) Appl. No.: 18/426,279

(22) Filed: Jan. 29, 2024

Related U.S. Application Data
(63) Continuation of application No. 16/989,092, filed on Aug. 10, 2020, now abandoned.
Application No. 16/989,092 is a continuation of application No. 15/974,447, filed on May 8, 2018, now abandoned.
(60) Provisional application No. 62/502,931, filed on May 8, 2017.

(51) Int. Cl. A62D 1/00; A62C 2/00

(52) U.S. Cl. CPC A62D 1/0028; A62C 2/00; A62D 1/0057

(57) ABSTRACT

Disclosed are fire extinguishant which comprises HFO-1224yd and methods, systems and container using such fire extinguishant.

### Cross Reference to Related Application

The present application is a Continuation of U.S. application Ser. No. 16/989,092, filed Aug. 10, 2020, which is a Continuation of U.S. application Ser. No. 15/974,447, filed May 8, 2018 which application claims the priority of U.S. Provisional Application No. 62/502,931, filed May 8, 2017, the entirety of which is herein incorporated by reference.

### FIELD OF THE INVENTION

The present invention relates to fire extinguishants, compositions which comprise fire extinguishants, and methods, systems and containers which use fire extinguishants.

### BACKGROUND

Numerous agents and methods for suppressing and extinguishing fires are known and can be selected for a particular fire, depending upon factors such as size, location and the type of combustible materials involved.

Certain halogenated hydrocarbon extinguishants have been used in the fire protection industry, particularly in applications including total flooding applications, where an enclosed area is completely filled (“flooded”) with an effective amount of the agent (e.g., computer rooms, storage vaults, telecommunications switching gear rooms, libraries, document archives, petroleum pipeline pumping stations, and the like), or in streaming applications where the extinguishant is directed towards the location of the fire (e.g., commercial hand-held extinguishers). Such extinguishants are not only effective but, unlike water, also function as “clean extinguishants”, causing little, if any, damage to the enclosure or its contents.

Previously, the most commonly-used halogenated hydrocarbon extinguishants have been bromine-containing compounds such as bromotrifluoromethane (CF₃ Br, Halon 1301) and bromochlorodifluoromethane (CF₂ ClBr, Halon 1211). While these bromine-containing halocarbons are highly effective in extinguishing fires and can be dispensed either from streaming equipment or from a total flooding system, these compounds have been linked to the destruction of stratospheric ozone (“ozone depletion”). For example, Halon 1301 has an Ozone Depletion Potential (ODP) of about 10, and Halon 1211 has and ODP of about 3. In 1987, a number of governments signed the Montreal Protocol to protect the global environment, setting forth a timetable for phasing out ozone depleting products, including the bromine-containing halocarbons.

Furthermore, certain of these compounds have issues with toxicity even at relatively low concentration levels. For example, Halon 1211 causes cardiac sensitization when used at levels above 1-2% vol in air.

In response to the requirement for a non-flammable, non-toxic alternative to the bromine-containing halocarbons, the industry developed a number of hydrofluorocarbons (HFCs) which have zero ozone depletion potential. For example, 1,1,1,2,3,3,3-heptafluoropropane (HFC-227ea) has been adopted in fire extinguishing applications, as it is effective in extinguishing fires, and also does not contribute to ozone depletion.

However, HFC-227ea has a Global Warming Potential (GWP) of about 3220 (according to IPCC (2007) Climate Change 2007: The Physical Science Basis. Contribution of Working Group I to the Fourth Assessment Report of the Intergovernmental Panel on Climate Change. S. Solomon et al., Cambridge University Press. Cambridge, United Kingdom). There is therefore a need in the art for clean fire extinguishants with both a low Ozone Depletion Potential (ODP) and a low Global Warming Potential (GWP).

It is understood in the art that replacement clean fire extinguishants must possess a mosaic of properties in order to be capable of effectively and safely extinguishing a fire, preferably with minimum unwanted consequences. That mosaic generally includes excellent fire extinguishing properties, as well as chemical stability, low or no toxicity, amongst others. The replacement clean fire extinguishants must also have acceptable environmental properties, i.e. low Global Warming Potential (GWP) and low Ozone Depletion Potential (ODP). However, the identification of a flame extinguishant meeting all of these requirements presents a significant challenge to those skilled in the art.

WO2004/037913 discloses that fluoroalkenes of formula (I), XCF_{z}R _{3-z}, where X is a C₂ or C₃ unsaturated, substituted or unsubstituted alkyl radical, each R is independently Cl, F, Br, I or H, and z is 1 to 3, can be used in a method of suppressing a flame.

US8961808 discloses azeotrope-like compositions consisting essentially of trans-1-chloro-2,3,3,3-tetrafluoropropene (HFO-1224yd(E)) and either trans-1,1,1,4,4,4-hexafluorobutene (HFO-1336mzz(E)) or trans-1,1,1,4,4,5,5,5-octafluoropentene (HFO-1438mzz(E)), and that these compositions may be used as a fire extinguishing or suppression agent.

U.S. Pat. No. 9,085,721 discloses azeotropic or azeotrope-like compositions consisting essentially of HFO-1224yd(E) and 1,1,1,2,3-pentafluoropropane (HFC-245eb), or HFO-1224yd(E) and HFO-1336mzz(E), and indicates that these compositions may be used in a method of extinguishing or suppressing a fire.

### BRIEF DESCRIPTION OF THE FIGURES

FIG. 1 illustrates schematically a total flooding system according to one embodiment of the present fire extinguishant methods and systems.

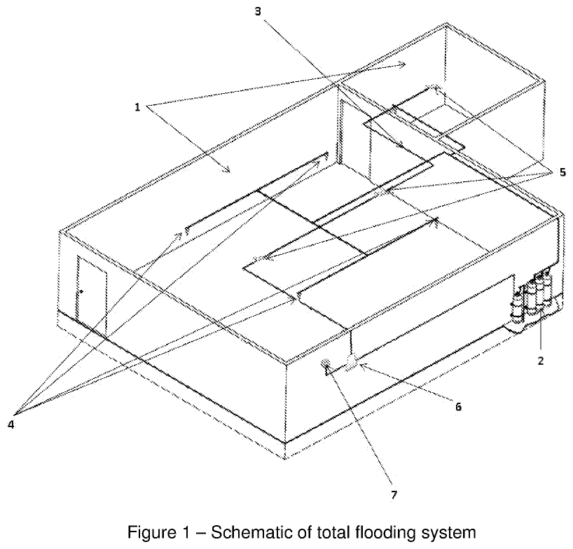

FIG. 2 is a schematic illustrative of the closed drum used in the “closed drum test” described in the Examples hereof.

### SUMMARY

Applicants have developed highly advantageous compositions, systems and methods which achieve rapid and effective flame suppression while avoiding one or more of the problems with prior compositions, methods and systems.

The present invention includes compositions comprising HFO-1224yd which can effectively be used as a fire extinguishant.

### DETAILED DESCRIPTION

The term “extinguish” is usually used to denote complete elimination of a fire, whereas, “suppression” is often used to denote reduction, but not necessarily total elimination, of a fire.

For the purposes of the description of the invention herein the term “about” with respect to an amount of an identified component means the amount of the identified component can vary by an amount of +/−1% by weight. The fire extinguishants of the invention include in preferred embodiments amounts of an identified compound or component specified as being “about” wherein the amount is the identified amount +/−0.5% by weight, or +/−0.3% by weight.

The term “about”, in relation to temperatures means that the stated temperature can vary by an amount of +/−5° C. In preferred embodiments, temperatures that are identified as “about” include the temperature as specified by an amount of +/−2° C. or +/−1° C., or +/−0.5° C.

The term “about” in relation to time expressed in seconds means that the stated time can vary by an amount of +/−2 s. In preferred embodiments, times that are identified as “about” , preferably include the time as specified of +/−1 s, or of +/−0.5 s.

The term “about” in relation to pressure expressed in psi means that the stated pressure can vary by an amount of +/−5 psi. In preferred embodiments, pressures that are identified as “about”, preferably include the pressure as specified of +/−2 psi, or +/−1 psi, or +/−0.5 psi.

The term HFO-1224yd refers to 1-chloro-2,3,3,3-tetrafluoropropene, and therefore, unless otherwise specified, this term encompasses the cis isomer (HFO-1224yd(Z)), the trans isomer (HFO-1224yd(E)), or any combination thereof.

The HFO-1224yd may comprise the unspecified isomer or other impurities, provided that these other components have no material effect on the characteristics of the specified isomer. The term HFO-1233zd refers to 1-chloro-3,3,3-trifluoropropene, and therefore, unless otherwise specified, this term encompasses the cis isomer (HFO-1233zd(Z)), the trans isomer (HFO-1233zd(E)), or any combination thereof.

The HFO-1233zd may comprise the unspecified isomer or other impurities, provided that these other components have no material effect on the characteristics of the

### Fire Extinguishants

The present disclosure provides a fire extinguishant comprising 1-chloro-2,3,3,3-tetrafluoropropene (HFO-1224yd).

The fire extinguishants described herein may have a Global Warming Potential (GWP) of not greater than about 500, preferably not greater than about 300, more preferably not greater than about 150. Preferably, the fire extinguishant has a GWP of not greater than about 150.

The fire extinguishants described herein may have an Ozone Depletion Potential of not greater than about 0.02, preferably not greater than about 0.01.

The HFO-1224yd may consist essentially of trans-HFO-1224yd, or the HFO-1224yd may consist of trans-HFO-1224yd. Alternatively, the HFO-1224yd may consist essentially of cis-HFO-1224yd, or the HFO-1224yd may consist of cis-HFO-1224yd. Preferably, the HFO-1224yd consists essentially of trans-HFO-1224yd, or the HFO-1224yd consists of trans-HFO-1224yd.

The present disclosure provides a fire extinguishant which comprises HFO-1224yd, with the proviso that the fire extinguishant does not consist essentially of

i) trans-1-chloro-2,3,3,3-tetrafluoropropene (HFO-1224yd(E)) and trans-1,1,1,4,4,5,5,5-octafluoro-2-pentene (HFO-1438mzz(E)), or ii) trans-1-chloro-2,3,3,3-tetrafluoropropene (HFO-1224yd(E)) and trans-1,1,1,4,4,4-hexafluoro-2-butene (HFO-1336mzz(E)), or iii) trans-1-chloro-2,3,3,3-tetrafluoropropene (HFO-1224yd(E)) and 1,1,1,2,3-pentafluoropropane (HFC-245eb).

Preferably, the present disclosure provides a fire extinguishant which comprises HFO-1224yd, and which does not comprise trans-1,1,1,4,4,5,5,5-octafluoro-2-pentene (HFO-1438mzz(E)), trans-1,1,1,4,4,4-hexafluoro-2-butene (HFO-1336mzz(E)), or 1,1,1,2,3-pentafluoropropane (HFC-245eb).

The present disclosure provides a fire extinguishant which comprises HFO-1224yd(E), with the proviso that the fire extinguishant does not consist essentially of:

i) trans-1-chloro-2,3,3,3-tetrafluoropropene (HFO-1224yd(E)) and trans-1,1,1,4,4,5,5,5-octafluoro-2-pentene (HFO-1438mzz(E)), or ii) trans-1-chloro-2,3,3,3-tetrafluoropropene (HFO-1224yd(E)) and trans-1,1,1,4,4,4-hexafluoro-2-butene (HFO-1336mzz(E)), or iii) trans-1-chloro-2,3,3,3-tetrafluoropropene (HFO-1224yd(E)) and 1,1,1,2,3-pentafluoropropane (HFC-245eb).

Preferably, the present disclosure provides a fire extinguishant which comprises HFO-1224yd(E), and which does not comprise trans-1,1,1,4,4,5,5,5-octafluoro-2-pentene (HFO-1438mzz(E)), trans-1,1,1,4,4,4-hexafluoro-2-butene (HFO-1336mzz(E)), or 1,1,1,2,3-pentafluoropropane (HFC-245eb).

For example, the composition may comprise HFO-1224yd, wherein the HFO-1224yd consists essentially of, or consists of, HFO-1224yd(E).

The present disclosure also relates to a fire extinguishant which comprises HFO-1224yd(Z).

For example, the composition may comprise HFO-1224yd, wherein the HFO-1224yd consists essentially of, or consists of, HFO-1224yd(Z).

It will be appreciated that the fire extinguishants described above may comprise the HFO-1224yd in widely ranging amounts.

For example, the HFO-1224yd may be present in an amount of at least about 5% by weight, at least about 15% by weight, at least about 30% by weight, at least about 50% by weight, at least about 70% by weight, or at least about 90% by weight of the fire extinguishant. It will be appreciated that the HFO-1224yd may be present in an amount of from about 5% to about 95% by weight, from about 10% to about 90% by weight, from about 20% to about 80% or from about 30% to about 70% by weight of the fire extinguishant.

### Extinguishants Consisting Essentially of, or Consisting of, HFO-1224yd

There is provided herein a fire extinguishant which consists essentially of HFO-1224yd. There is also provided a fire extinguishant which consists of HFO-1224yd.

The HFO-1224yd may be present as the cis isomer, the trans isomer, or any combination thereof.

Thus, the disclosure also provides a fire extinguishant which consists essentially of HFO-1224yd, wherein the HFO-1224yd consists essentially of HFO-1224yd(E). It will also be appreciated that the disclosure provides a fire extinguishant which consists of HFO-1224yd, wherein the HFO-1224yd consists of HFO-1224yd(E).

Alternatively, there is provided a fire extinguishant which consists essentially of HFO-1224yd, wherein the HFO-1224yd consists essentially of HFO-1224yd(Z). It will also be appreciated that the disclosure provides a fire extinguishant which consists of HFO-1224yd, wherein the HFO-1224yd consists of HFO-1224yd(Z).

### Extinguishants Comprising HFO-1224yd and One or more Compounds

In a further feature of the disclosure, there is provided a fire extinguishant which comprises HFO-1224yd and one or more compounds selected from the group consisting of HFC-245fa, HCFC-22, HFC-23, HCFC-123, HCFC-123a, HCFC-123b, HCFC-124, HCFC-124a, HFC-125, HFC-134, HCFC-134a, HCFC-132, HFC-227ea, HFC-227ca, HFC-236fa, HFC-236ea, HFC-236cb, HFC-245ea, HFC-245eb, HFC-245cb, CF₃I, 1,1,1,2,2,4,5,5,5-nonafluoro-4-(trifluoromethyl)-3-pentanone (FK5-1-12), 1-chloro-3,3,3-trifluoropropene (HFO-1233zd) and combinations thereof. Preferably, the fire extinguishant consists essentially of, or consists of, HFO-1224yd and the one or more compounds.

The HFO-1224yd may be present as the cis isomer, the trans isomer, or any combination thereof.

Thus, the disclosure provides a fire extinguishant which comprises HFO-1224yd, and one or more compounds selected from the group consisting of HFC-245fa, HCFC-22, HFC-23, HCFC-123, HCFC-123a, HCFC-123b, HCFC-124, HCFC-124a, HFC-125, HFC-134, HCFC-134a, HCFC-132, HFC-227ea, HFC-227ca, HFC-236fa, HFC-236ea, HFC-236cb, HFC-245ea, HFC-245eb, HFC-245cb, CF₃I, FK5-1-12, HFO-1233zd and combinations thereof, wherein the HFO-1224yd consists essentially of, or consists of, HFO-1224yd(E). Preferably, the fire extinguishant consists essentially of, or consists of, HFO-1224yd and the one or more compounds.

The disclosure also provides a fire extinguishant which comprises HFO-1224yd, and one or more compounds selected from the group consisting of HFC-245fa, HCFC-22, HFC-23, HCFC-123, HCFC-123a, HCFC-123b, HCFC-124, HCFC-124a, HFC-125, HFC-134, HCFC-134a, HCFC-132, HFC-227ea, HFC-227ca, HFC-236fa, HFC-236ea, HFC-236cb, HFC-245ea, HFC-245eb, HFC-245cb, CF₃I, FK5-1-12, HFO-1233zd and combinations thereof, wherein the HFO-1224yd consists essentially of, or consists of, HFO-1224yd(Z). Preferably, the fire extinguishant consists essentially of, or consists of, HFO-1224yd and the one or more compounds.

The HFO-1224yd may be present in the fire extinguishant in widely ranging amounts. For example, the HFO-1224yd may be present in an amount of at least about 5% by weight, at least about 15% by weight, at least about 30% by weight, at least about 50% by weight, at least about 70% by weight, or at least about 90% by weight of the fire extinguishant. It will be appreciated that the HFO-1224yd may be present in an amount of from about 5% to about 95% by weight, from about 10% to about 90% by weight, from about 20% to about 80% or from about 30% to about 70% by weight of the fire extinguishant.

Thus, the fire extinguishant may comprise HFO-1224yd and one or more compounds selected from the group consisting of HFC-245fa, HCFC-22, HFC-23, HCFC-123, HCFC-123a, HCFC-123b, HCFC-124, HCFC-124a, HFC-125, HFC-134, HCFC-134a, HCFC-132, HFC-227ea, HFC-227ca, HFC-236fa, HFC-236ea, HFC-236cb, HFC-245ea, HFC-245eb, HFC-245cb, CF₃I, FK5-1-12, HFO-1233zd and combinations thereof, wherein the HFO-1224yd is present in an amount of at least about 5% by weight, at least about 15% by weight, at least about 30% by weight, at least about 50% by weight, at least about 70% by weight, or at least about 90% by weight of the fire extinguishant. It will be appreciated that the fire extinguishant may comprise HFO-1224yd and one or more compounds selected from the group consisting of HFC-245fa, HCFC-22, HFC-23, HCFC-123, HCFC-123a, HCFC-123b, HCFC-124, HCFC-124a, HFC-125, HFC-134, HCFC-134a, HCFC-132, HFC-227ea, HFC-227ca, HFC-236fa, HFC-236ea, HFC-236cb, HFC-245ea, HFC-245eb, HFC-245cb, CF ₃I, FK5-1-12, HFO-1233zd and combinations thereof, wherein the HFO-1224yd is present in an amount of from about 5% to about 95% by weight, from about 10% to about 90% by weight, from about 20% to about 80% or from about 30% to about 70% by weight of the fire extinguishant. Preferably, the fire extinguishant consists essentially of, or consists of, HFO-1224yd and the one or more compounds.

In addition, the fire extinguishant may comprise HFO-1224yd and one or more compounds selected from the group consisting of HFC-245fa, HCFC-22, HFC-23, HCFC-123, HCFC-123a, HCFC-123b, HCFC-124, HCFC-124a, HFC-125, HFC-134, HCFC-134a, HCFC-132, HFC-227ea, HFC-227ca, HFC-236fa, HFC-236ea, HFC-236cb, HFC-245ea, HFC-245eb, HFC-245cb, CF₃I, FK5-1-12, HFO-1233zd and combinations thereof, wherein the HFO-1224yd is present in an amount of at least about 5% by weight, at least about 15% by weight, at least about 30% by weight, at least about 50% by weight, at least about 70% by weight, or at least about 90% by weight of the fire extinguishant, and wherein the HFO-1224yd consists essentially of, or consists of, HFO-1224yd(E). It will be appreciated that the fire extinguishant may comprise HFO-1224yd and one or more compounds selected from the group consisting of HFC-245fa, HCFC-22, HFC-23, HCFC123, HCFC123a, HCFC-123b, HCFC-124, HCFC-124a, HFC125, HFC-134, HCFC-134a, HCFC-132, HFC-227ea, HFC-227ca, HFC-236fa, HFC-236ea, HFC-236cb, HFC-245ea, HFC-245eb, HFC-245cb, CF₃I, FK5-1-12,HFO-1233zd and combinations thereof, wherein the HFO-1224yd is present in an amount of from about 5% to about 95% by weight, from about 10% to about 90% by weight, from about 20% to about 80% or from about 30% to about 70% by weight of the fire extinguishant, and wherein the HFO-1224yd consists essentially of, or consists of, HFO-1224yd(E). Preferably, the fire extinguishant consists essentially of, or consists of, HFO-1224yd and the one or more compounds.

In addition, the fire extinguishant may comprise HFO-1224yd and one or more compounds selected from the group consisting of HFC-245fa, HCFC-22, HFC-23, HCFC123, HCFC123a, HCFC-123b, HCFC-124, HCFC-124a, HFC125, HFC-134, HCFC-134a, HCFC-132, HFC-227ea, HFC-227ca, HFC-236fa, HFC-236ea, HFC-236cb, HFC-245ea, HFC-245eb, HFC-245cb, CF₃I, FK5-1-12, HFO-1233zd and combinations thereof, wherein the HFO-1224yd is present in an amount of at least about 5% by weight, at least about 15% by weight, at least about 30% by weight, at least about 50% by weight, at least about 70% by weight, or at least about 90% by weight of the fire extinguishant, and wherein the HFO-1224yd consists essentially of, or consists of, HFO-1224yd(Z). It will be appreciated that the fire extinguishant may comprise HFO-1224yd and one or more compounds selected from the group consisting of HFC-245fa, HCFC-22, HFC-23, HCFC123, HCFC123a, HCFC-123b, HCFC-124, HCFC-124a, HFC125, HFC-134, HCFC-134a, HCFC-132, HFC-227ea, HFC-227ca, HFC-236fa, HFC-236ea, HFC-236cb, HFC-245ea, HFC-245eb, HFC-245cb, CF₃ I, FK5-1-12, HFO-1233zd and combinations thereof, wherein the HFO-1224yd is present in an amount of from about 5% to about 95% by weight, from about 10% to about 90% by weight, from about 20% to about 80% or from about 30% to about 70% by weight of the fire extinguishant, and wherein the HFO-1224yd consists essentially of, or consists of, HFO-1224yd(Z). Preferably, the fire extinguishant consists essentially of, or consists of, HFO-1224yd and the one or more compounds.

The fire extinguishants comprising, consisting essentially of, or consisting of HFO-1224yd and the one or more compounds may have a Global Warming Potential (GWP) of not greater than about 500, preferably not greater than about 300, more preferably not greater than about 150. Preferably, the fire extinguishant has a GWP of not greater than about 150.

The fire extinguishants comprising, consisting essentially of, or consisting of HFO-1224yd and the one or more compounds may have an Ozone Depletion Potential of not greater than about 0.02, preferably not greater than about 0.01.

### Extinguishants comprising HFO-1224yd and HFO-1233zd

Preferably, the disclosure provides a fire extinguishant comprising HFO-1224yd and HFO-1233zd.

The HFO-1224yd may be present as the cis isomer, the trans isomer, or any combination thereof.

Thus, the invention provides a fire extinguishant comprising HFO-1224yd and HFO-1233zd, wherein the HFO-1224yd consists essentially of, or consists of, HFO-1224yd(E).

It will be appreciated that the HFO-1233zd may present as the cis isomer, the trans isomer, or any combination thereof. Thus, the invention also provides a fire extinguishant comprising HFO-1224yd and HFO-1233zd, wherein the HFO-1224yd consists essentially of, or consists of, HFO-1224yd(E), and wherein the HFO-1233zd consists essentially of, or consists of, HFO-1233zd(E). The invention also provides a fire extinguishant comprising HFO-1224yd and HFO-1233zd, wherein the HFO-1224yd consists essentially of, or consists of, HFO-1224yd(E), and wherein the HFO-1233zd consists essentially of, or consists of, HFO-1233zd(Z).

Alternatively, the disclosure provides a fire extinguishant comprising HFO-1224yd and HFO-1233zd, wherein the HFO-1224yd consists essentially of, or consists of, HFO-1224yd(Z).

It will be appreciated that the HFO-1233zd may present as the cis isomer, the trans isomer, or any combination thereof. Thus, the disclosure also provides a fire extinguishant comprising HFO-1224yd and HFO-1233zd, wherein the HFO-1224yd consists essentially of, or consists of, HFO-1224yd(Z), and wherein the HFO-1233zd consists essentially of, or consists of, HFO-1233zd(E). The disclosure also provides a fire extinguishant comprising HFO-1224yd and HFO-1233zd, wherein the HFO-1224yd consists essentially of, or consists of, HFO-1224yd(Z), and wherein the HFO-1233zd consists essentially of, or consists of, HFO-1233zd(Z).

The HFO-1224yd and HFO-1233zd may be present in widely ranging amounts. For example, the HFO-1224yd may be present in an amount of at least about 5% by weight, at least about 15% by weight, at least about 30% by weight, at least about 50% by weight, at least about 70% by weight, or at least about 90% by weight of the fire extinguishant. It will be appreciated that the HFO-1224yd may be present in an amount of from about 5% to about 95% by weight, from about 10% to about 90% by weight, from about 20% to about 80% or from about 30% to about 70% by weight of the fire extinguishant.

It will be appreciated that the HFO-1233zd may be present in an amount of at least about 2% by weight, at least about 5% by weight or at least about 10% by weight of the fire extinguishant.

Furthermore, the HFO-1224yd may be present in the fire extinguishant in an amount of at least about 15% by weight, and/or the HFO-1233zd may be present in the fire extinguishant in an amount of at least about 15% by weight. It will also be appreciated that the HFO-1224yd may be present in the fire extinguishant in an amount of at least about 25% by weight, and/or the HFO-1233zd may be present in the fire extinguishant in an amount of at least about 25% by weight.

Thus, the disclosure provides a fire extinguishant comprising HFO-1224yd and HFO-1233zd, wherein the HFO-1224yd is present in an amount of at least about 5% by weight, at least about 15% by weight, at least about 30% by weight, at least about 50% by weight, at least about 70% by weight, or at least about 90% by weight of the fire extinguishant and/or wherein the HFO-1233zd is present in an amount of at least about 2% by weight, at least about 5% by weight or at least about 10% by weight of the fire extinguishant. Preferably, the fire extinguishant consists essentially of, or consists of, the HFO-1224yd and HFO-1233zd.

The disclosure also provides a fire extinguishant comprising HFO-1224yd and HFO-1233zd, wherein the HFO-1224yd is present in an amount of from about 5% to about 95% by weight, from about 10% to about 90% by weight, from about 20% to about 80% or from about 30% to about 70% by weight of the fire extinguishant. Preferably, the fire extinguishant consists essentially of, or consists of, the HFO-1224yd and HFO-1233zd.

The disclosure also provides a fire extinguishant comprising HFO-1224yd and HFO-1233zd, wherein the HFO-1224yd is present in an amount of at least about 15% by weight, and the HFO-1233zd is present in an amount of at least about 15% by weight, or wherein the HFO-1224yd is present in an amount of at least about 25% by weight, and the HFO-1233zd is present in an amount of at least about 25% by weight. Preferably, the fire extinguishant consists essentially of, or consists of, the HFO-1224yd and HFO-1233zd.

In addition, the disclosure provides a fire extinguishant comprising HFO-1224yd and HFO-1233zd, wherein the HFO-1224yd is present in an amount of at least about 5% by weight, at least about 15% by weight, at least about 30% by weight, at least about 50% by weight, at least about 70% by weight, or at least about 90% by weight of the fire extinguishant and/or wherein the HFO-1233zd is present in an amount of at least about 2% by weight, at least about 5% by weight or at least about 10% by weight of the fire extinguishant, wherein the HFO-1224yd consists essentially of, or consists of, HFO-1224yd(E). The HFO-1233zd may consist essentially of, or consist of, HFO-1233zd(E), or HFO-1233zd(Z). Preferably, the HFO-1233zd consists essentially of, or consists of, HFO-1233zd(E). Preferably, the fire extinguishant consists essentially of, or consists of, the HFO-1224yd and HFO-1233zd.

The disclosure also provides a fire extinguishant comprising HFO-1224yd and HFO-1233zd, wherein the HFO-1224yd is present in an amount of from about 5% to about 95% by weight, from about 10% to about 90% by weight, from about 20% to about 80% or from about 30% to about 70% by weight of the fire extinguishant, wherein the HFO-1224yd consists essentially of, or consists of, HFO-1224yd(E). The HFO-1233zd may consist essentially of, or consist of, HFO-1233zd(E), or HFO-1233zd(Z). Preferably, the HFO-1233zd consists essentially of, or consists of, HFO-1233zd(E). Preferably, the fire extinguishant consists essentially of, or consists of, the HFO-1224yd and HFO-1233zd.

The disclosure also provides a fire extinguishant comprising HFO-1224yd and HFO-1233zd, wherein the HFO-1224yd is present in an amount of at least about 15% by weight, and/or the HFO-1233zd is present in an amount of at least about 15% by weight, or wherein the HFO-1224yd is present in an amount of at least about 25% by weight, and/or the HFO-1233zd is present in an amount of at least about 25% by weight, wherein the HFO-1224yd consists essentially of, or consists of, HFO-1224yd(E). The HFO-1233zd may consist essentially of, or consist of, HFO-1233zd(E), or HFO-1233zd(Z). Preferably, the HFO-1233zd consists essentially of, or consists of, HFO-1233zd(E). Preferably, the fire extinguishant consists essentially of, or consists of, the HFO-1224yd and HFO-1233zd.

In addition, the disclosure provides a fire extinguishant comprising HFO-1224yd and HFO-1233zd, wherein the HFO-1224yd is present in an amount of at least about 5% by weight, at least about 15% by weight, at least about 30% by weight, at least about 50% by weight, at least about 70% by weight, or at least about 90% by weight of the fire extinguishant and/or wherein the HFO-1233zd is present in an amount of at least about 2% by weight, at least about 5% by weight or at least about 10% by weight of the fire extinguishant, wherein the HFO-1224yd consists essentially of, or consists of, HFO-1224yd(Z). The HFO-1233zd may consist essentially of, or consist of, HFO-1233zd(E), or HFO-1233zd(Z). Preferably, the HFO-1233zd consists essentially of, or consists of, HFO-1233zd(E). Preferably, the fire extinguishant consists essentially of, or consists of, the HFO-1224yd and HFO-1233zd.

The disclosure also provides a fire extinguishant comprising HFO-1224yd and HFO-1233zd, wherein the HFO-1224yd is present in an amount of from about 5% to about 95% by weight, from about 10% to about 90% by weight, from about 20% to about 80% or from about 30% to about 70% by weight of the fire extinguishant, wherein the HFO-1224yd consists essentially of, or consists of, HFO-1224yd(Z). The HFO-1233zd may consist essentially of, or consist of, HFO-1233zd(E), or HFO-1233zd(Z). Preferably, the HFO-1233zd consists essentially of, or consists of, HFO-1233zd(E). Preferably, the fire extinguishant consists essentially of, or consists of, the HFO-1224yd and HFO-1233zd.

The disclosure also provides a fire extinguishant comprising HFO-1224yd and HFO-1233zd, wherein the HFO-1224yd is present in an amount of at least about 15% by weight, and/or the HFO-1233zd is present in an amount of at least about 15% by weight, or wherein the HFO-1224yd is present in an amount of at least about 25% by weight, and/or the HFO-1233zd is present in an amount of at least about 25% by weight, wherein the HFO-1224yd consists essentially of, or consists of, HFO-1224yd(Z). The HFO-1233zd may consist essentially of, or consist of, HFO-1233zd(E), or HFO-1233zd(Z). Preferably, the HFO-1233zd consists essentially of, or consists of, HFO-1233zd(E). Preferably, the fire extinguishant consists essentially of, or consists of, the HFO-1224yd and HFO-1233zd.

It will be appreciated that the fire extinguishant comprising HFO-1224yd and

HFO-1233zd may comprise one or more further components. For example, the fire extinguishant comprising HFO-1224yd and HFO-1233zd may comprise one or more further compounds selected from the group consisting of HFC-245fa, HCFC-22, HFC-23, HCFC123, HCFC123a, HCFC-123b, HCFC-124, HCFC-124a, HFC125, HFC-134, HCFC-134a, HCFC-132, HFC-227ea, HFC-227ca, HFC-236fa, HFC-236ea, HFC-236cb, HFC-245ea, HFC-245eb, HFC-245cb, CF₃I, and FK5-1-12.

Alternatively, the fire extinguishant may consist essentially of, or consist of, the HFO-1224yd and HFO-1233zd. Preferably, the fire extinguishant consists essentially of, or consists of, the HFO-1224yd and HFO-1233zd.

The fire extinguishants comprising, consisting essentially of, or consisting of HFO-1224yd and HFO-1233zd may have a Global Warming Potential (GWP) of not greater than about 500, preferably not greater than about 300, more preferably not greater than about 150. Preferably, the fire extinguishant has a GWP of not greater than about 150.

The fire extinguishants comprising, consisting essentially of, or consisting of HFO-1224yd and HFO-1233zd may have an Ozone Depletion Potential of not greater than about 0.02, preferably not greater than about 0.01.

### Extinguishants Comprising HFO-1224yd and FK5-1-12

The disclosure also provides a fire extinguishant comprising HFO-1224yd and FK5-1-12.

The HFO-1224yd may be present as the cis isomer, the trans isomer, or any combination thereof. Thus, the disclosure provides a fire extinguishant comprising HFO-1224yd and FK5-1-12, wherein the HFO-1224yd consists essentially of, or consists of, HFO-1224yd(E).

Alternatively, the disclosure provides a fire extinguishant comprising HFO-1224yd and FK5-1-12, wherein the HFO-1224yd consists essentially of, or consists of, HFO-1224yd(Z).

The HFO-1224yd and FK5-1-12 may be present in widely ranging amounts. For example, the HFO-1224yd may be present in an amount of at least about 5% by weight, at least about 15% by weight, at least about 30% by weight, at least about 50% by weight, at least about 70% by weight, or at least about 90% by weight of the fire extinguishant. It will be appreciated that the HFO-1224yd may be present in an amount of from about 5% to about 95% by weight, from about 10% to about 90% by weight, from about 20% to about 80% or from about 30% to about 70% by weight of the fire extinguishant.

It will be appreciated that the FK5-1-12 may be present in an amount of at least about 2% by weight, at least about 5% by weight or at least about 10% by weight of the fire extinguishant.

Furthermore, the HFO-1224yd may be present in the fire extinguishant in an amount of at least about 15% by weight, and/or the FK5-1-12 may be present in the fire extinguishant in an amount of at least about 15% by weight. It will also be appreciated that the HFO-1224yd may be present in the fire extinguishant in an amount of at least about 25% by weight, and/or the FK5-1-12 may be present in the fire extinguishant in an amount of at least about 25% by weight.

Thus, the disclosure provides a fire extinguishant comprising HFO-1224yd and FK5-1-12, wherein the HFO-1224yd is present in an amount of at least about 5% by weight, at least about 15% by weight, at least about 30% by weight, at least about 50% by weight, at least about 70% by weight, or at least about 90% by weight of the fire extinguishant and/or wherein the FK5-1-12 is present in an amount of at least about 2% by weight, at least about 5% by weight or at least about 10% by weight of the fire extinguishant. Preferably, the fire extinguishant consists essentially of, or consists of, the HFO-1224yd and FK5-1-12.

The disclosure also provides a fire extinguishant comprising HFO-1224yd and FK5-1-12, wherein the HFO-1224yd is present in an amount of from about 5% to about 95% by weight, from about 10% to about 90% by weight, from about 20% to about 80% or from about 30% to about 70% by weight of the fire extinguishant. Preferably, the fire extinguishant consists essentially of, or consists of, the HFO-1224yd and FK5-1-12.

The disclosure also provides a fire extinguishant comprising HFO-1224yd and FK5-1-12, wherein the HFO-1224yd is present in an amount of at least about 15% by weight, and/or the FK5-1-12 is present in an amount of at least about 15% by weight, or wherein the HFO-1224yd is present in an amount of at least about 25% by weight, and/or the FK5-1-12 is present in an amount of at least about 25% by weight. Preferably, the fire extinguishant consists essentially of, or consists of, the HFO-1224yd and FK5-1-12.

In addition, the disclosure provides a fire extinguishant comprising HFO-1224yd and FK5-1-12, wherein the HFO-1224yd consists essentially of, or consists of, HFO-1224yd(E), and wherein the HFO-1224yd is present in an amount of at least about 5% by weight, at least about 15% by weight, at least about 30% by weight, at least about 50% by weight, at least about 70% by weight, or at least about 90% by weight of the fire extinguishant and/or wherein the FK5-1-12 is present in an amount of at least about 2% by weight, at least about 5% by weight or at least about 10% by weight of the fire extinguishant. Preferably, the fire extinguishant consists essentially of, or consists of, the HFO-1224yd and FK5-1-12.

The disclosure also provides a fire extinguishant comprising HFO-1224yd and FK5-1-12, wherein the HFO-1224yd consists essentially of, or consists of, HFO-1224yd(E), and wherein the HFO-1224yd is present in an amount of from about 5% to about 95% by weight, from about 10% to about 90% by weight, from about 20% to about 80% or from about 30% to about 70% by weight of the fire extinguishant. Preferably, the fire extinguishant consists essentially of, or consists of, the HFO-1224yd and FK5-1-12.

The disclosure also provides a fire extinguishant comprising HFO-1224yd and FK5-1-12, wherein the HFO-1224yd consists essentially of, or consists of, HFO-1224yd(E), and wherein the HFO-1224yd is present in an amount of at least about 15% by weight, and/or the FK5-1-12 is present in an amount of at least about 15% by weight, or wherein the HFO-1224yd is present in an amount of at least about 25% by weight, and/or the FK5-1-12 is present in an amount of at least about 25% by weight. Preferably, the fire extinguishant consists essentially of, or consists of, the HFO-1224yd and FK5-1-12.

In addition, the disclosure provides a fire extinguishant comprising HFO-1224yd and FK5-1-12, wherein the HFO-1224yd consists essentially of, or consists of, HFO-1224yd(Z), and wherein the HFO-1224yd is present in an amount of at least about 5% by weight, at least about 15% by weight, at least about 30% by weight, at least about 50% by weight, at least about 70% by weight, or at least about 90% by weight of the fire extinguishant and/or wherein the FK5-1-12 is present in an amount of at least about 2% by weight, at least about 5% by weight or at least about 10% by weight of the fire extinguishant. Preferably, the fire extinguishant consists essentially of, or consists of, the HFO-1224yd and FK5-1-12.

The disclosure also provides a fire extinguishant comprising HFO-1224yd and FK5-1-12, wherein the HFO-1224yd consists essentially of, or consists of, HFO-1224yd(Z), and wherein the HFO-1224yd is present in an amount of from about 5% to about 95% by weight, from about 10% to about 90% by weight, from about 20% to about 80% or from about 30% to about 70% by weight of the fire extinguishant. Preferably, the fire extinguishant consists essentially of, or consists of, the HFO-1224yd and FK5-1-12.

The disclosure also provides a fire extinguishant comprising HFO-1224yd and FK5-1-12, wherein the HFO-1224yd consists essentially of, or consists of, HFO-1224yd(Z), and/or wherein the HFO-1224yd is present in an amount of at least about 15% by weight, and the FK5-1-12 is present in an amount of at least about 15% by weight, or wherein the HFO-1224yd is present in an amount of at least about 25% by weight, and/or the FK5-1-12 is present in an amount of at least about 25% by weight. Preferably, the fire extinguishant consists essentially of, or consists of, the HFO-1224yd and FK5-1-12.

It will be appreciated that the fire extinguishant comprising HFO-1224yd and FK5-1-12 may comprise one or more further components. For example, the fire extinguishant comprising HFO-1224yd and FK5-1-12 may comprise one or more further compounds selected from the group consisting of HFC-245fa, HCFC-22, HFC-23, HCFC123, HCFC123a, HCFC-123b, HCFC-124, HCFC-124a, HFC125, HFC-134, HCFC-134a, HCFC-132, HFC-227ea, HFC-227ca, HFC-236fa, HFC-236ea, HFC-236cb, HFC-245ea, HFC-245eb, HFC-245cb, CF₃I, and HFO-1233zd.

Alternatively, the fire extinguishant may consist essentially of, or consist of, the HFO-1224yd and FK5-1-12. Preferably, the fire extinguishant consists essentially of, or consists of, the HFO-1224yd and FK5-1-12.

The fire extinguishants comprising, consisting essentially of, or consisting of HFO-1224yd and FK5-1-12 may have a Global Warming Potential (GWP) of not greater than about 500, preferably not greater than about 300, more preferably not greater than about 150. Preferably, the fire extinguishant has a GWP of not greater than about 150.

The fire extinguishants comprising, consisting essentially of, or consisting of HFO-1224yd and FK5-1-12 may have an Ozone Depletion Potential of not greater than about 0.02, preferably not greater than about 0.01.

### Extinguishants Comprising HFO-1224yd and HFC-227ea

The disclosure also provides a fire extinguishant comprising HFO-1224yd and HFC-227ea.

The HFO-1224yd may be present as the cis isomer, the trans isomer, or any combination thereof. Thus, the disclosure provides a fire extinguishant comprising HFO-1224yd and HFC-227ea, wherein the HFO-1224yd consists essentially of, or consists of, HFO-1224yd(E).

Alternatively, the disclosure provides a fire extinguishant comprising HFO-1224yd and HFC-227ea wherein the HFO-1224yd consists essentially of, or consists of, HFO-1224yd(Z).

The HFO-1224yd and HFC-227ea may be present in widely ranging amounts. For example, the HFO-1224yd may be present in an amount of at least about 5% by weight, at least about 15% by weight, at least about 30% by weight, at least about 50% by weight, at least about 70% by weight, or at least about 90% by weight of the fire extinguishant. It will be appreciated that the HFO-1224yd may be present in an amount of from about 5% to about 95% by weight, from about 10% to about 90% by weight, from about 20% to about 80% or from about 30% to about 70% by weight of the fire extinguishant.

It will be appreciated that the HFC-227ea may be present in an amount of at least about 2% by weight, at least about 5% by weight or at least about 10% by weight of the fire extinguishant.

Furthermore, the HFO-1224yd may be present in the fire extinguishant in an amount of at least about 15% by weight, and/or the HFC-227ea may be present in the fire extinguishant in an amount of at least about 15% by weight. It will also be appreciated that the HFO-1224yd may be present in the fire extinguishant in an amount of at least about 25% by weight, and/or the HFC-227ea may be present in the fire extinguishant in an amount of at least about 25% by weight.

Thus, the disclosure provides a fire extinguishant comprising HFO-1224yd and HFC-227ea, wherein the HFO-1224yd is present in an amount of at least about 5% by weight, at least about 15% by weight, at least about 30% by weight, at least about 50% by weight, at least about 70% by weight, or at least about 90% by weight of the fire extinguishant and/or wherein the HFC-227ea is present in an amount of at least about 2% by weight, at least about 5% by weight or at least about 10% by weight of the fire extinguishant. Preferably, the fire extinguishant consists essentially of, or consists of, the HFO-1224yd and HFC-227ea.

The disclosure also provides a fire extinguishant comprising HFO-1224yd and HFC-227ea, wherein the HFO-1224yd is present in an amount of from about 5% to about 95% by weight, from about 10% to about 90% by weight, from about 20% to about 80% or from about 30% to about 70% by weight of the fire extinguishant. Preferably, the fire extinguishant consists essentially of, or consists of, the HFO-1224yd and HFC-227ea.

The disclosure also provides a fire extinguishant comprising HFO-1224yd and HFC-227ea, wherein the HFO-1224yd is present in an amount of at least about 15% by weight, and/or the HFC-227ea is present in an amount of at least about 15% by weight, or wherein the HFO-1224yd is present in an amount of at least about 25% by weight, and/or the HFC-227ea is present in an amount of at least about 25% by weight. Preferably, the fire extinguishant consists essentially of, or consists of, the HFO-1224yd and HFC-227ea.

In addition, the disclosure provides a fire extinguishant comprising HFO-1224yd and HFC-227ea, wherein the HFO-1224yd consists essentially of, or consists of, HFO-1224yd(E), and wherein the HFO-1224yd is present in an amount of at least about 5% by weight, at least about 15% by weight, at least about 30% by weight, at least about 50% by weight, at least about 70% by weight, or at least about 90% by weight of the fire extinguishant and/or wherein the HFC-227ea is present in an amount of at least about 2% by weight, at least about 5% by weight or at least about 10% by weight of the fire extinguishant. Preferably, the fire extinguishant consists essentially of, or consists of, the HFO-1224yd and HFC-227ea.

The disclosure also provides a fire extinguishant comprising HFO-1224yd and HFC-227ea, wherein the HFO-1224yd consists essentially of, or consists of, HFO-1224yd(E), and wherein the HFO-1224yd is present in an amount of from about 5% to about 95% by weight, from about 10% to about 90% by weight, from about 20% to about 80% or from about 30% to about 70% by weight of the fire extinguishant. Preferably, the fire extinguishant consists essentially of, or consists of, the HFO-1224yd and HFC-227ea.

The disclosure also provides a fire extinguishant comprising HFO-1224yd and HFC-227ea, wherein the HFO-1224yd consists essentially of, or consists of, HFO-1224yd(E), and wherein the HFO-1224yd is present in an amount of at least about 15% by weight, and/or the HFC-227ea is present in an amount of at least about 15% by weight, or wherein the HFO-1224yd is present in an amount of at least about 25% by weight, and/or the HFC-227ea is present in an amount of at least about 25% by weight. Preferably, the fire extinguishant consists essentially of, or consists of, the HFO-1224yd and HFC-227ea.

In addition, the disclosure provides a fire extinguishant comprising HFO-1224yd and HFC-227ea, wherein the HFO-1224yd consists essentially of, or consists of, HFO-1224yd(Z), and wherein the HFO-1224yd is present in an amount of at least about 5% by weight, at least about 15% by weight, at least about 30% by weight, at least about 50% by weight, at least about 70% by weight, or at least about 90% by weight of the fire extinguishant and/or wherein the HFC-227ea is present in an amount of at least about 2% by weight, at least about 5% by weight or at least about 10% by weight of the fire extinguishant. Preferably, the fire extinguishant consists essentially of, or consists of, the HFO-1224yd and HFC-227ea.

The disclosure also provides a fire extinguishant comprising HFO-1224yd and HFC-227ea, wherein the HFO-1224yd consists essentially of, or consists of, HFO-1224yd(Z), and wherein the HFO-1224yd is present in an amount of from about 5% to about 95% by weight, from about 10% to about 90% by weight, from about 20% to about 80% or from about 30% to about 70% by weight of the fire extinguishant. Preferably, the fire extinguishant consists essentially of, or consists of, the HFO-1224yd and HFC-227ea.

The disclosure also provides a fire extinguishant comprising HFO-1224yd and HFC-227ea, wherein the HFO-1224yd consists essentially of, or consists of, HFO-1224yd(Z), and wherein the HFO-1224yd is present in an amount of at least about 15% by weight, and/or the HFC-227ea is present in an amount of at least about 15% by weight, or wherein the HFO-1224yd is present in an amount of at least about 25% by weight, and/or the HFC-227ea is present in an amount of at least about 25% by weight. Preferably, the fire extinguishant consists essentially of, or consists of, the HFO-1224yd and HFC-227ea.

The fire extinguishant comprising HFO-1224yd and HFC-227ea may comprise one or more further components. For example, the fire extinguishant comprising HFO-1224yd and HFC-227ea may comprise one or more further compounds selected from the group consisting of HFC-245fa, HCFC-22, HFC-23, HCFC123, HCFC123a, HCFC-123b, HCFC-124, HCFC-124a, HFC125, HFC-134, HCFC-134a, HCFC-132, HFC-227ca, HFC-236fa, HFC-236ea, HFC-236cb, HFC-245ea, HFC-245eb, HFC-245cb, CF₃I, FK5-1-12, and HFO-1233zd.

Alternatively, the fire extinguishant may consist essentially of, or consist of, the HFO-1224yd and HFC-227ea. Preferably, the fire extinguishant consists essentially of, or consists of, the HFO-1224yd and HFC-227ea.

The fire extinguishants comprising, consisting essentially of, or consisting of HFO-1224yd and HFC-227ea may have a Global Warming Potential (GWP) of not greater than about 500, preferably not greater than about 300, more preferably not greater than about 150. Preferably, the fire extinguishant has a GWP of not greater than about 150.

The fire extinguishants comprising, consisting essentially of, or consisting of HFO-1224yd and HFC-227ea may have an Ozone Depletion Potential of not greater than about 0.02, preferably not greater than about 0.01.

### Extinguishants Comprising HFO-1224yd and CF₃I

The disclosure also provides a fire extinguishant comprising HFO-1224yd and CF₃I.

The HFO-1224yd may be present as the cis isomer, the trans isomer, or any combination thereof. Thus, the disclosure provides a fire extinguishant comprising HFO-1224yd and CF₃I, wherein the HFO-1224yd consists essentially of, or consists of, HFO-1224yd(E).

Alternatively, the disclosure provides a fire extinguishant comprising HFO-1224yd and CF₃I wherein the HFO-1224yd consists essentially of, or consists of, HFO-1224yd(Z).

The HFO-1224yd and CF₃I may be present in widely ranging amounts. For example, the HFO-1224yd may be present in an amount of at least about 5% by weight, at least about 15% by weight, at least about 30% by weight, at least about 50% by weight, at least about 70% by weight, or at least about 90% by weight of the fire extinguishant. It will be appreciated that the HFO-1224yd may be present in an amount of from about 5% to about 95% by weight, from about 10% to about 90% by weight, from about 20% to about 80% or from about 30% to about 70% by weight of the fire extinguishant.

It will be appreciated that the CF₃I may be present in an amount of at least about 2% by weight, at least about 5% by weight or at least about 10% by weight of the fire extinguishant.

Furthermore, the HFO-1224yd may be present in the fire extinguishant in an amount of at least about 15% by weight, and/or the CF₃I may be present in the fire extinguishant in an amount of at least about 15% by weight. It will also be appreciated that the HFO-1224yd may be present in the fire extinguishant in an amount of at least about 25% by weight, and/or the CF₃I may be present in the fire extinguishant in an amount of at least about 25% by weight.

Thus, the disclosure provides a fire extinguishant comprising HFO-1224yd and CF₃I, wherein the HFO-1224yd is present in an amount of at least about 5% by weight, at least about 15% by weight, at least about 30% by weight, at least about 50% by weight, at least about 70% by weight, or at least about 90% by weight of the fire extinguishant and/or wherein the CF₃I is present in an amount of at least about 2% by weight, at least about 5% by weight or at least about 10% by weight of the fire extinguishant. Preferably, the fire extinguishant consists essentially of, or consists of, the HFO-1224yd and CF₃I.

The disclosure also provides a fire extinguishant comprising HFO-1224yd and CF₃ I, wherein the HFO-1224yd is present in an amount of from about 5% to about 95% by weight, from about 10% to about 90% by weight, from about 20% to about 80% or from about 30% to about 70% by weight of the fire extinguishant. Preferably, the fire extinguishant consists essentially of, or consists of, the HFO-1224yd and CF₃I.

The disclosure also provides a fire extinguishant comprising HFO-1224yd and CF₃I, wherein the HFO-1224yd is present in an amount of at least about 15% by weight, and/or the CF₃I is present in an amount of at least about 15% by weight, or wherein the HFO-1224yd is present in an amount of at least about 25% by weight, and/or the CF₃I is present in an amount of at least about 25% by weight. Preferably, the fire extinguishant consists essentially of, or consists of, the HFO-1224yd and CF₃I.

In addition, the disclosure provides a fire extinguishant comprising HFO-1224yd and CF ₃I, wherein the HFO-1224yd consists essentially of, or consists of, HFO-1224yd(E), and wherein the HFO-1224yd is present in an amount of at least about 5% by weight, at least about 15% by weight, at least about 30% by weight, at least about 50% by weight, at least about 70% by weight, or at least about 90% by weight of the fire extinguishant and/or wherein the CF₃I is present in an amount of at least about 2% by weight, at least about 5% by weight or at least about 10% by weight of the fire extinguishant. Preferably, the fire extinguishant consists essentially of, or consists of, the HFO-1224yd and CF₃I.

The disclosure also provides a fire extinguishant comprising HFO-1224yd and CF₃I, wherein the HFO-1224yd consists essentially of, or consists of, HFO-1224yd(E), and wherein the HFO-1224yd is present in an amount of from about 5% to about 95% by weight, from about 10% to about 90% by weight, from about 20% to about 80% or from about 30% to about 70% by weight of the fire extinguishant. Preferably, the fire extinguishant consists essentially of, or consists of, the HFO-1224yd and CF₃I.

The disclosure also provides a fire extinguishant comprising HFO-1224yd and CF₃I, wherein the HFO-1224yd consists essentially of, or consists of, HFO-1224yd(E), and wherein the HFO-1224yd is present in an amount of at least about 15% by weight, and/or the CF₃I is present in an amount of at least about 15% by weight, or wherein the HFO-1224yd is present in an amount of at least about 25% by weight, and/or the CF₃I is present in an amount of at least about 25% by weight. Preferably, the fire extinguishant consists essentially of, or consists of, the HFO-1224yd and CF₃I.

In addition, the disclosure provides a fire extinguishant comprising HFO-1224yd and CF₃I, wherein the HFO-1224yd consists essentially of, or consists of, HFO-1224yd(Z), and wherein the HFO-1224yd is present in an amount of at least about 5% by weight, at least about 15% by weight, at least about 30% by weight, at least about 50% by weight, at least about 70% by weight, or at least about 90% by weight of the fire extinguishant and/or wherein the CF₃I is present in an amount of at least about 2% by weight, at least about 5% by weight or at least about 10% by weight of the fire extinguishant. Preferably, the fire extinguishant consists essentially of, or consists of, the HFO-1224yd and CF₃I.

The disclosure also provides a fire extinguishant comprising HFO-1224yd and CF₃I, wherein the HFO-1224yd consists essentially of, or consists of, HFO-1224yd(Z), and wherein the HFO-1224yd is present in an amount of from about 5% to about 95% by weight, from about 10% to about 90% by weight, from about 20% to about 80% or from about 30% to about 70% by weight of the fire extinguishant. Preferably, the fire extinguishant consists essentially of, or consists of, the HFO-1224yd and CF₃I.

The disclosure also provides a fire extinguishant comprising HFO-1224yd and CF₃I, wherein the HFO-1224yd consists essentially of, or consists of, HFO-1224yd(Z), and wherein the HFO-1224yd is present in an amount of at least about 15% by weight, and/or the CF₃I is present in an amount of at least about 15% by weight, or wherein the HFO-1224yd is present in an amount of at least about 25% by weight, and/or the CF₃I is present in an amount of at least about 25% by weight. Preferably, the fire extinguishant consists essentially of, or consists of, the HFO-1224yd and CF₃I.

The fire extinguishant comprising HFO-1224yd and CF₃I may comprise one or more further components. For example, the fire extinguishant comprising HFO-1224yd and CF₃I may comprise one or more further compounds selected from the group consisting of HFC-245fa, HCFC-22, HFC-23, HCFC123, HCFC123a, HCFC-123b,

HCFC-124, HCFC-124a, HFC125, HFC-134, HCFC-134a, HCFC-132, HFC-227ca, HFC-227ea, HFC-236fa, HFC-236ea, HFC-236cb, HFC-245ea, HFC-245eb, HFC-245cb, FK5-1-12, and HFO-1233zd.

Alternatively, the fire extinguishant may consist essentially of, or consist of, the HFO-1224yd and CF₃I. Preferably, the fire extinguishant consists essentially of, or consists of, the HFO-1224yd and CF₃I.

The fire extinguishants comprising, consisting essentially of, or consisting of HFO-1224yd and CF₃ I may have a Global Warming Potential (GWP) of not greater than about 500, preferably not greater than about 300, more preferably not greater than about 150. Preferably, the fire extinguishant has a GWP of not greater than about 150.

The fire extinguishants comprising, consisting essentially of, or consisting of HFO-1224yd and CF₃I may have an Ozone Depletion Potential of not greater than about 0.02, preferably not greater than about 0.01.

### Compositions

The disclosure also provides a composition which comprises a fire extinguishant as defined above.

The composition may comprise at least about 70% by weight, preferably at least about 90% by weight, more preferably at least about 95% by weight of the fire extinguishant described herein.

The composition may comprise a propellant. The propellant may be used to propel the extinguishant from a container in which it is stored to the location of the fire to be extinguished. Preferably, the propellant is selected from the group consisting of argon (Ar), nitrogen (N₂), helium (He), carbon dioxide (CO₂), and combinations thereof. More preferably, the propellant is selected from Ar and N₂.

The composition may comprise one or more detoxifying agents. The detoxifying agent may be present in the composition in an amount of from about 0.1% to about 10% by weight. The one or more detoxifying agents may be selected from the group consisting of citral, limonene, terpinene, sabinene, ocimene, beta-pinene, phytol, squalene, oleanolic, lutein, oleic acid, eleostearic acid, palmitoleic acid, citronnellal, dipentene, terpinolene, menthadiene, myrcene, turpentine, vitamin A, lanosterol, lycopene, alpha-terpineol, linoleic acid, lincanic acid, petroselenic acid, citronellol, menthol, sylvestrene, zingiberene, alpha-pinene, camphor, abietic acid, saponin, beta-carotene, para-cymeme, linolenic acid, ricinoleic acid, vaccenic acid and combinations thereof, preferably the one or more detoxifying agents is limonene.

The composition may consist essentially of the fire extinguishant, the propellant and optionally the one or more detoxifying agents as defined above.

### Methods and Systems

The present disclosure also provides a method of extinguishing a flame, or a method of suppressing a flame. The method comprises the step of contacting a flame with a fire extinguishant described herein.

Alternatively, the method comprises the step of contacting a flame with a composition comprising a fire extinguishant described herein. The composition may comprise at least about 70% by weight, preferably at least about 90% by weight, more preferably at least about 95% by weight of the fire extinguishant disclosed herein.

The composition may comprise a propellant. The propellant may be used to propel the extinguishant from a container in which it is stored to the location of the fire to be extinguished. Preferably, the propellant is selected from the group consisting of argon (Ar), nitrogen (N₂), helium (He), carbon dioxide (CO₂), and combinations thereof. More preferably, the propellant is selected from Ar and N₂.

The composition may comprise one or more detoxifying agents. The detoxifying agent may be present in the composition in an amount of from about 0.1% to about 10% by weight. The one or more detoxifying agents may be selected from the group consisting of citral, limonene, terpinene, sabinene, ocimene, beta-pinene, phytol, squalene, oleanolic, lutein, oleic acid, eleostearic acid, palmitoleic acid, citronnellal, dipentene, terpinolene, menthadiene, myrcene, turpentine, vitamin A, lanosterol, lycopene, alpha-terpineol, linoleic acid, lincanic acid, petroselenic acid, citronellol, menthol, sylvestrene, zingiberene, alpha-pinene, camphor, abietic acid, saponin, beta-carotene, para-cymeme, linolenic acid, ricinoleic acid, vaccenic acid and combinations thereof, preferably the one or more detoxifying agents is limonene.

The composition may consist essentially of the fire extinguishant, the propellant and optionally the one or more detoxifying agents as defined above.

It will be appreciated that the fire extinguishant or composition comprising the fire extinguishant may be sprayed or poured onto the flame. Alternatively, at least a portion of the flame may be immersed in the fire extinguishant or composition comprising the fire extinguishant.

The fire extinguishant of the invention can be used in total flooding applications, and in streaming applications.

### Total Flooding Applications

The disclosure provides a method for extinguishing a flame in a total flooding application. Total flooding applications can either be used to extinguish a flame in an enclosed area, or to inert an enclosed area thereby preventing a flame from propagating. In a total flooding application, the fire extinguishant disclosed herein is discharged into an enclosed area. The fire extinguishant then disperses, evaporating if it is initially a liquid, to form a mixture of air and gaseous fire extinguishant. Successful fire extinguishing occurs when the fire extinguishant exceeds the minimum extinguishing concentration (MEC), thereby causing flame extinguishment. However, it is desirable to avoid using excessive quantities of fire extinguishant to prevent the creation of an air/fire extinguishant atmosphere which is harmful to people due to hypoxia, fire extinguishant toxicity, or both.

The present disclosure provides a method for extinguishing a flame in an enclosed area, the method comprising the steps of:

Optionally detecting the flame in the enclosed area; and

Discharging a fire extinguishant described herein, or a composition comprising a fire extinguishant described herein into the enclosed area, thereby extinguishing the flame.

The fire extinguishant may be any of the fire extinguishants described herein. The fire extinguishant may be discharged into the enclosed area in an amount sufficient to extinguish the flame. Preferably, the flame is extinguished within about 60 seconds, more preferably within about 30 seconds of the fire extinguishant first being discharged into the enclosed area. Preferably, the extinguishant is discharged within about 20 seconds, more preferably within about 10 seconds.

The temperature within the enclosed area may be at least about 15° C., at least about 20° C., at least about 25° C., or at least about 30° C.

The relative humidity (RH) within the enclosed area may be at least about 20%, preferably of at least about 35%, preferably of at least about 50%, more preferably of at least about 65%, more preferably of at least about 80%.

The disclosure also provides a method of preventing a fire in an enclosed area (i.e. a method of inerting). Thus, the disclosure also provides a method of preventing a fire, the method comprising the step of discharging a fire extinguishant described herein, or a composition comprising the fire extinguishant described herein, into the enclosed area.

The fire extinguishant may be any of the fire extinguishants described herein. The fire extinguishant may be discharged into the enclosed area in an amount sufficient to prevent a flame from propagating. Preferably, the flame is extinguished within about 60 seconds, more preferably within about 30 seconds of the fire extinguishant first being discharged into the enclosed area. Preferably, the extinguishant is discharged within about 20 seconds, more preferably within about 10 seconds.

The temperature within the enclosed area may be at least about 15° C., at least about 20° C., at least about 25° C., or at least about 30° C.

The relative humidity (RH) within the enclosed area may be at least about 20%, preferably of at least about 35%, preferably of at least about 50%, more preferably of at least about 65%, more preferably of at least about 80%.

The enclosed area may be part (or the entirety) of a building or structure, a watercraft vessel, a motor or rail vehicle, a spacecraft or an aircraft. The term “building or structure” encompasses both permanent and semi-permanent buildings or structures, and may be a residential, commercial or industrial building or structure. For example, the enclosed area may be a vault; a computer room (e.g. a computer server room); an aircraft cabin or cockpit; an engine compartment of a watercraft vessel, motor vehicle, rail vehicle, spacecraft or aircraft; a museum; a library; a document archive; a petroleum pipeline pumping station; an aircraft or water vessel cargo bay, etc.

Thus, the above methods may be used to protect an item of value, an item which is susceptible to water damage, or a flammable material (e.g. a container containing a flammable gas or liquid), which is contained within the enclosed area from fire.

The disclosure provides a total flooding system. The total flooding system comprises an enclosed area(s) (1), one or more container(s) (2) comprising a fire extinguishant described herein, a distribution piping network (3), and an orifice (such as a nozzle or sprinkler) (4) for delivering the fire extinguishant from the distribution piping network (3) to the enclosed area(s) (1). The system may optionally comprise one or more detector(s) (5) for detecting a fire in the enclosed area(s) (1). The system may also comprise a detection control system (6) and/or an alarm (7). The detection control system (6) may be in communication with the one or more container(s) (2), such that when a fire is detected, the detection control system (6) causes the fire extinguishant to be released from the one or more container(s) (2).

The fire extinguishant may be any of the fire extinguishants described herein. The container may comprise the fire extinguishant in an amount of at least about 70% by weight, preferably at least about 90% by weight, more preferably at least about 95% by weight.

The container may additionally comprise a propellant. The propellant may be used to propel the extinguishant from the container. Preferably, the propellant is selected from the group consisting of argon (Ar), nitrogen (N₂), helium (He), carbon dioxide (CO₂), and combinations thereof. More preferably, the propellant is selected from Ar and N₂.

The container may be pressurized to a pressure of from about 80 to about 800 psi at 21° C.

The container may alternatively or additionally comprise one or more detoxifying agents. The detoxifying agent may be present in the container in an amount of from about 0.1% to about 10% by weight. The one or more detoxifying agents may be selected from the group consisting of citral, limonene, terpinene, sabinene, ocimene, beta-pinene, phytol, squalene, oleanolic, lutein, oleic acid, eleostearic acid, palmitoleic acid, citronnellal, dipentene, terpinolene, menthadiene, myrcene, turpentine, vitamin A, lanosterol, lycopene, alpha-terpineol, linoleic acid, lincanic acid, petroselenic acid, citronellol, menthol, sylvestrene, zingiberene, alpha-pinene, camphor, abietic acid, saponin, beta-carotene, para-cymeme, linolenic acid, ricinoleic acid, vaccenic acid and combinations thereof, preferably the one or more detoxifying agents is limonene.

The Minimum Extinguishing Concentration (MEC) can be determined using the cup burner method as set out in Annex B of NFPA-2001, 2015 Edition, for extinguishing a Class B test fire.

It will be appreciated that many national and international standards will set a

Minimum Design Concentration (MDC), which is equal to the MEC, multiplied by a small excess (e.g. multiplied by 1.3), thereby resulting in a concentration having a safety margin factored into this amount.

### Streaming Applications

The present disclosure also provides a method for extinguishing a flame using a streaming application.

Thus, the disclosure provides a method for suppressing or extinguishing a flame in a streaming application, the method comprising the steps of:

Transporting a container comprising a fire extinguishant disclosed herein, or a composition comprising a fire extinguishant disclosed herein, to the vicinity of the flame, wherein said container is capable of discharging the fire extinguishant or composition; and

Discharging the fire extinguishant or composition into an area surrounding the flame thereby suppressing or extinguishing the flame.

The fire extinguishant may be any of the fire extinguishants described herein. The composition may comprise at least about 70% by weight, preferably at least about 90% by weight, more preferably at least about 95% by weight of the fire extinguishant of the invention.

The composition may comprise a propellant. The propellant may be used to propel the extinguishant from a container in which it is stored to the location of the fire to be extinguished. Preferably, the propellant is selected from the group consisting of argon (Ar), nitrogen (N₂), helium (He), carbon dioxide (CO ₂), and combinations thereof. More preferably, the propellant is selected from Ar and N ₂ .

The composition may comprise one or more detoxifying agents. The detoxifying agent may be present in the composition in an amount of from about 0.1% to about 10% by weight. The one or more detoxifying agents may be selected from the group consisting of citral, limonene, terpinene, sabinene, ocimene, beta-pinene, phytol, squalene, oleanolic, lutein, oleic acid, eleostearic acid, palmitoleic acid, citronnellal, dipentene, terpinolene, menthadiene, myrcene, turpentine, vitamin A, lanosterol, lycopene, alpha-terpineol, linoleic acid, lincanic acid, petroselenic acid, citronellol, menthol, sylvestrene, zingiberene, alpha-pinene, camphor, abietic acid, saponin, beta-carotene, para-cymeme, linolenic acid, ricinoleic acid, vaccenic acid and combinations thereof, preferably the one or more detoxifying agents is limonene.

The composition may consist essentially of the fire extinguishant, the propellant and optionally the one or more detoxifying agents as defined above.

The present disclosure also provides a container comprising a fire extinguishant of the invention. The fire extinguishant may be any of the fire extinguishants described herein. The container is configured to discharge the fire extinguishant. The fire extinguishant may be sprayed or poured into the area surrounding the flame.

The fire extinguishant may be discharged manually, or it may be discharged automatically from the container. For example, the cylinder may contain a valve assembly which, when actuated, releases the fire extinguishant, or the composition comprising the fire extinguishant, from the cylinder.

The container may comprise at least about 70% by weight, preferably at least about 90% by weight, more preferably at least about 95% by weight of the fire extinguishant.

The container may comprise a propellant. The propellant may be used to propel the extinguishant from the container to the location of the fire to be extinguished. Preferably, the propellant is selected from the group consisting of argon (Ar), nitrogen (N₂), helium (He), carbon dioxide (CO₂), and combinations thereof. More preferably, the propellant is selected from Ar and N₂.

The container may be pressurized to a pressure of from about 80 to about 800 psi at 21° C.

The container may comprise one or more detoxifying agents. The detoxifying agent may be present in the container in an amount of from about 0.1% to about 10% by weight. The one or more detoxifying agents may be selected from the group consisting of citral, limonene, terpinene, sabinene, ocimene, beta-pinene, phytol, squalene, oleanolic, lutein, oleic acid, eleostearic acid, palmitoleic acid, citronnellal, dipentene, terpinolene, menthadiene, myrcene, turpentine, vitamin A, lanosterol, lycopene, alpha-terpineol, linoleic acid, lincanic acid, petroselenic acid, citronellol, menthol, sylvestrene, zingiberene, alpha-pinene, camphor, abietic acid, saponin, beta-carotene, para-cymeme, linolenic acid, ricinoleic acid, vaccenic acid and combinations thereof, preferably the one or more detoxifying agents is limonene.

The container may consist essentially of the fire extinguishant, the propellant and optionally the one or more detoxifying agents as defined above.

The container may be a handheld fire extinguisher.

### Tests

The Minimum Extinguishing Concentration (MEC) can be determined using the cup burner method as set out in Annex B of NFPA-2001, 2015 Edition, for extinguishing a Class B test fire.

It will be appreciated that many national and international standards will set a

Minimum Design Concentration (MDC), which is equal to the MEC, multiplied by a small excess (e.g. multiplied by 1.3), thereby resulting in a concentration having a safety margin factored into this amount.

The ability of fire extinguishants to function effectively at high temperatures (e.g. at temperatures at or above about 25° C., or at or above about 30° C.), and/or high humidity (e.g. at a relative humidity of at least about 20%, preferably of at least about 35%, preferably of at least about 50%, more preferably of at least about 65%, more preferably of at least about 80%) can be determined using the following method, referred to herein as the “closed drum test”. Applicants believe that the fire extinguishants of the present invention are capable of achieving such exceptional results and that such results are surprising and unexpected.

### Apparatus

1 Drum, open-head, 55 gal (208 dm3), modified as follows:

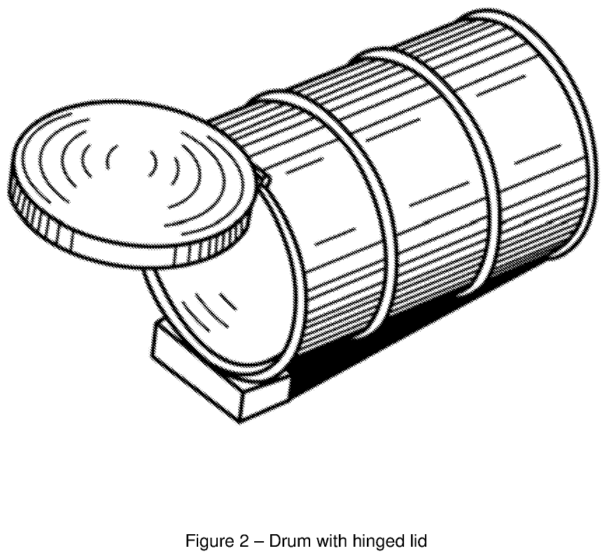

1.1 Fit a closure over the open drum head. The closure may be either a hinged lid (FIG. 2), or a ½-mil (0.0127-mm) thickness of polyamide film. If the film is used, apply it as follows:

1.1.1 Stretch the film over the open end of the drum and hold it in place by a strong rubber band, that will stretch 1 in. (25 mm) when a 1-lb (0.45-kg) mass is hung from its lowest point when around the drum.

1.1.2 Cut a 1-in. (25-mm) vertical slit in the film, beginning at a point 2 in. (51 mm) from the top of the drum.

1.1.3 Draw the film taut over the opening.

1.2 Bore a circular opening 1 in. (25 mm) in diameter through the base, about 2 in. (51 mm) from the edge, in such a position that when the drum is on its side the hole will be at the top.

1.3 A metal base 4 in. (102 mm) long, 4 in. (102 mm) wide, and at least 1/16 in. (1.6 mm) thick upon which a pipe having an internal diameter of 3 in (76 mm) and a length of 4 in. (102 mm) is welded.

1.4 Optionally, a 6-in. (152-mm) square opening may be cut through the centre of the drum base and securely covered with a piece of safety glass. Method

2.1 A container is charged with the fire extinguishant and nitrogen gas to a pressure of 125 psi. The container has a short length of tubing with an internal diameter of ⅛ in. (3.2 mm) is attached to the container through which the extinguishant can be released.

2.2 Lay the drum on its side (FIG. 2), and adjust the temperature of the room in which the drum is contained to the desired level.

2.3 Ensure that the centre of the plate on which the pipe is welded is positioned half-way from each end of the drum.

2.4 Add 1 in. (25 mm) of water and 25 ml of n-heptane with a minimum purity of 99% to the cup created by the pipe welded to the metal base.

2.5 Place a hot plate in the drum, and then place a beaker of boiling water on the hot plate. Boil the water to provide the desired humidity. The relative humidity is measured using a probe, and the absolute humidity is calculated from this value.

2.6 Immediately light the fuel in the pipe and secure the closure. (If the film closure is used, ignite the fuel by means of a taper through the 1-in. (25-mm) circular opening.)

2.7 Shake the container and hold it upright or, if necessary, in such a position that the liquid contents can be sprayed directly into the drum. The container is configured to release the full charge into the drum.

2.8 As quickly as possible, place the dispenser at the 1-in. (25-mm) opening and spray directly into the drum, directing the spray toward the centre of the opposite end, until the fire is extinguished, or for a period up to 120 s, whichever occurs first. The time limit begins when the extinguishant is first released into the drum.

2.9 After each test, open the drum to clear the atmosphere, and clean the drum of any residues which might affect future tests.

The fire extinguishant may be stored externally to an enclosed area(s) (1) in one or more container(s) (2). The one or more container(s) (2) is connected to a distribution piping network (3), which allows the fire extinguishant to be delivered to the enclosed area(s) (1). The fire extinguishant may be delivered from the distribution piping network (3) to the enclosed area(s) (1) through a nozzle or sprinkler (4).

The total flooding system may additionally comprise one or more detectors (5) for detecting a fire in the enclosed area(s) (1).

The total flooding system may also comprise a detection control system (6) and/or an alarm (7). The detection control system (6) may be in communication with the one or more container(s) (2), such that when a fire is detected, the detection control system (6) causes the fire extinguishant to be released from the one or more container(s) (2).

The container (2) may additionally comprise a propellant. The propellant may be selected from the group consisting of Ar, N₂, He, CO₂, and combinations thereof. The propellant may be used to pressurize the container. The container (2) may be pressurized to a pressure of from about 80 to about 800 psi at 21° C.

For example, if a fire is present in the enclosed area(s) (1), or the enclosed area(s) (1) is to be inerted, the fire extinguishant of the invention may be discharged from the one or more container(s) (2) into the distribution piping network (3). The fire extinguishant then travels through the distribution piping network (3), and is then delivered to the enclosed area (1) through a nozzle or sprinkler (4).

### EXAMPLES

### Example 1

The Minimum Extinguishing Concentration (MEC) of 1224yd(Z) was determined using the cup burner method as set out in Annex B of NFPA-2001, 2015 Edition, for extinguishing a Class B test fire. An air flow rate of 40 L/min was used.

The fuel was a commercial grade n-heptane (initial boiling point of a minimum of 90° C., maximum dry point of 100° C., and specific gravity of 0.69-0.73).

The tests were conducted at ambient laboratory temperature (23° C.±2° C.), and the fuel in the cup was brought to ambient temperature (23° C.±2° C.).

The MEC of 1224yd(Z) was determined to be 5.9 vol % in air. The ability to achieve MEC at such a relatively low level is an advantageous and unexpected result.

1. A fire extinguishant which comprises HFO-1224yd, with the proviso that the fire extinguishant does not consist essentially of:
i) trans-1-chloro-2,3,3,3-tetrafluoropropene (HFO-1224yd(E)) and trans-1,1,1,4,4,5,5,5-octafluoro-2-pentene (HFO-1438mzz(E)), or
ii) trans-1-chloro-2,3,3,3-tetrafluoropropene (HFO-1224yd(E)) and trans-1,1,1,4,4,4-hexafluoro-2-butene (HFO-1336mzz(E)), or iii) trans-1-chloro-2,3,3,3-tetrafluoropropene (HFO-1224yd(E)) and 1,1,1,2,3-pentafluoropropane (HFC-245eb).

2. The fire extinguishant of claim 1, wherein the fire extinguishant does not comprise trans-1,1,1,4,4,5,5,5-octafluoro-2-pentene (HFO-1438mzz(E)), trans-1,1,1,4,4,4-hexafluoro-2-butene (HFO-1336mzz(E)), or 1,1,1,2,3-pentafluoropropane (HFC-245eb).

3. The fire extinguishant of claim 1 wherein the HFO-1224yd consists essentially of HFO-1224yd(E).

4. The fire extinguishant of claim 1 wherein the HFO-1224yd consists essentially of HFO-1224yd(Z).

5. A fire extinguishant which consists essentially of HFO-1224yd.

6. The fire extinguishant of claim 5, wherein the HFO-1224yd consists essentially of HFO-1224yd(Z).

7. The fire extinguishant of claim 5, wherein the HFO-1224yd consists essentially of HFO-1224yd(E).

8. The fire extinguishant of claim 1, having a Global Warming Potential of not greater than about 500.

9. The fire extinguishant of claim 1, having a Global Warming Potential of not greater than about 150.

10. The fire extinguishant of claim 1, having an Ozone Depletion Potential of not greater than about 0.02.

11. The fire extinguishant of claim 1, having an Ozone Depletion Potential of not greater than about 0.01.

12. A composition comprising a fire extinguishant according to claim 1.

13. The composition of claim 12, wherein the composition further comprises a propellant.

14. The composition of claim 13, wherein the propellant is selected from the group consisting of N₂, CO₂, Ar, He, and combinations thereof.

15. The composition of claims 14, wherein the composition additionally comprises one or more detoxifying agents.

16. The composition of claim 15, wherein the one or more detoxifying agents is present in the composition in an amount of from about 0.1% to about 10% by weight.

17. The composition of claim 16 wherein the one or more detoxifying agents is selected from the group consisting of citral, limonene, terpinene, sabinene, ocimene, beta-pinene, phytol, squalene, oleanolic, lutein, oleic acid, eleostearic acid, palmitoleic acid, citronnellal, dipentene, terpinolene, menthadiene, myrcene, turpentine, vitamin A, lanosterol, lycopene, alpha-terpineol, linoleic acid, lincanic acid, petroselenic acid, citronellol, menthol, sylvestrene, zingiberene, alpha-pinene, camphor, abietic acid, saponin, beta-carotene, para-cymeme, linolenic acid, ricinoleic acid, vaccenic acid and combinations thereof.

18. A method for suppressing or extinguishing a flame, the method comprising the step of contacting a flame with a fire extinguishant according to claim 1.

19. The method of claim 18 wherein the fire extinguishant or composition is sprayed or poured onto the flame, or wherein at least a portion of the flame is immersed in the fire extinguishant or the composition.

20. A container comprising a fire extinguishant according to claim 1.
